(19) United States
(12) Patent Application Publication
(10) Pub. No.: US 2025/0114861 A1
(43) Pub. Date: Apr. 10, 2025

(54) WELDING SYSTEM AND SPOT CHECK METHOD FOR WELDING SYSTEM

(71) Applicant: CONTEMPORARY AMPEREX TECHNOLOGY (HONG KONG) LIMITED, Hong Kong (CN)

(72) Inventors: Yingjun LI, Ningde (CN); Congcheng QI, Ningde (CN); Shixiong ZHENG, Ningde (CN); Jian LI, Ningde (CN); Qiangguo ZHAO, Ningde (CN); Xiupeng YE, Ningde (CN); Xu ZHANG, Ningde (CN)

(21) Appl. No.: 18/884,985

(22) Filed: Sep. 13, 2024

Related U.S. Application Data
(63) Continuation of application No. PCT/CN2023/139503, filed on Dec. 18, 2023.

(30) Foreign Application Priority Data
Oct. 8, 2023 (CN) 202311289467.8

(51) Int. Cl. B23K 26/03; B23K 26/08

(52) U.S. Cl. CPC B23K 26/032; B23K 26/0884

(57) ABSTRACT

A method includes obtaining a set of ranging values between a rangefinder and at least two posts in a battery product, where the set of ranging values is obtained by the rangefinder through ranging of the at least two posts along a first direction parallel to an optical axis of a laser galvanometer after the rangefinder is calibrated based on a first position in the first direction that is a position of a focal point of the laser galvanometer in the first direction, and the rangefinder being at a fixed distance from the laser galvanometer in the first direction; determining a first offset of a welding surface of the battery product relative to the focal point 10 based on the set of ranging values; and determining a first position adjustment amount for the laser galvanometer in the first direction based on the first offset and a first defocus amount.

### CROSS-REFERENCE TO RELATED APPLICATIONS

The present application is a continuation of International Application No. PCT/CN2023/139503, filed on Dec. 18, 2023, which claims priority to Chinese Patent Application No. 202311289467.8, filed on Oct. 8, 2023 and entitled “WELDING SYSTEM AND SPOT CHECK METHOD FOR WELDING SYSTEM”, the entire contents of both of which are incorporated herein by reference.

### TECHNICAL FIELD

The present disclosure relates to, without limitation, the field of welding technologies for battery products, and in particular, to a welding system and a spot check method for a welding system.

### BACKGROUND ART

New energy batteries are increasingly widely applied in life and industry, for example, new energy vehicles equipped with the batteries have been used widely. In addition, batteries are also increasingly applied in the field of energy storage, etc.

In a process of producing a battery product, the welding of posts is a very important step, which allows a plurality of battery cells in the battery product to be electrically connected using busbars in a cell connection system (CCS). However, during the welding of the posts, due to an inappropriate distance between a laser galvanometer and a post in the battery product to be welded, it may lead to a poor welding quality, affecting a product yield.

### SUMMARY

In view of this, embodiments of the present disclosure provide at least a welding system and a spot check method for a welding system, which make it possible to determine a more appropriate position adjustment amount for a laser galvanometer in a welding device, resulting in a more appropriate distance between the position-adjusted laser galvanometer and a post in a battery product to be welded, thus improving a welding quality of the battery product and increasing a product yield.

The technical solutions of the embodiments of the present disclosure are implemented as follows.

An embodiment of the present disclosure provides a welding system, including: a controller, a robot, a laser galvanometer, and a rangefinder, where

the rangefinder and the laser galvanometer are both connected to a drive end of the robot in a driven manner, and the rangefinder is at a fixed distance from the laser galvanometer in a first direction, the first direction being parallel to an optical axis of the laser galvanometer;
the robot is configured to drive the rangefinder to perform ranging, along the first direction, of at least two posts in a battery product to be welded, so as to obtain a set of ranging values between the at least two posts and the rangefinder; the rangefinder is calibrated based on a first position in the first direction, the first position being a position of a focal point of the laser galvanometer in the first direction;
the controller is configured to determine a first offset of a welding surface of the battery product relative to the focal point based on the set of ranging values; and determine a first position adjustment amount for the laser galvanometer in the first direction based on the first offset and a first defocus amount corresponding to a current welding process; and
the robot is further configured to drive, based on the first position adjustment amount, the laser galvanometer to be subjected to a position adjustment in the first direction; and drive the position-adjusted laser galvanometer to move perpendicularly to the first direction, so as to weld the at least two posts.

According to the welding system in the embodiments of the present disclosure, since the first offset of the welding surface of the battery product relative to the focal point of the laser galvanometer is determined based on the set of ranging values between the rangefinder and the at least two posts in the battery product, the first offset has a higher accuracy; in addition, during the process of determining the first position adjustment amount for adjusting the laser galvanometer, the first offset and the first defocus amount corresponding to the current welding process are both considered, so that a more appropriate position adjustment amount can be determined for the laser galvanometer in a welding device, resulting in a more appropriate distance between the position-adjusted laser galvanometer and the post in the battery product to be welded, thus improving the welding quality of the battery product and increasing the product yield.

In some embodiments, the controller is further configured to perform at least one of operations of: sending, if a target parameter meets a preset condition, a welding instruction to the robot to cause the robot to drive the position-adjusted laser galvanometer to move perpendicularly to the first direction, so as to weld the at least two posts, the target parameter including at least one of the following: the set of ranging values, the first offset, and the first position adjustment amount; and outputting prompt information if the target parameter does not meet the preset condition. In this way, the fool-proofing management and control of the target parameter can be added to the welding process of the posts, thereby making it possible to further improve the welding quality of the battery product.

In some embodiments, the target parameter includes the first position adjustment amount, and the preset condition includes at least one of the following: a difference between a second position adjustment amount and the first position adjustment amount being within an adjustment difference scope, and a second distance difference corresponding to each ranging value in the set of ranging values being within a preset second distance difference scope, where the second distance difference corresponding to the ranging value is a sum of a first distance difference corresponding to the ranging value and the second position adjustment amount, the first distance difference corresponding to the ranging value is a distance difference between the ranging value and a reference distance, and the reference distance is a distance between the calibrated rangefinder and the focal point; the robot is further configured to: before subjecting the laser galvanometer to the position adjustment in the first direction, drive the rangefinder to perform ranging, along the first direction, of a preset ranging point, so as to obtain a first ranging value; and after subjecting the laser galvanometer to the position adjustment in the first direction, drive the rangefinder to perform ranging, along the first direction, of the preset ranging point, so as to obtain a second ranging value; and the controller is further configured to determine the second position adjustment amount based on a difference between the second ranging value and the first ranging value. In this way, a difference between the second position adjustment amount and the first position adjustment amount can represent the adjustment difference between the first position adjustment amount and the actual amount of movement of the laser galvanometer in the first direction that is caused by the position adjustment of the laser galvanometer in the first direction; and the sum of the first distance difference of the post and the second position adjustment amount can represent an actual distance offset of the post relative to the focal point of the laser galvanometer. Therefore, the welding quality of the battery product can be further improved by performing fool-proofing management and control of the adjustment difference and/or the actual distance offset corresponding to each post.

In some embodiments, the welding system further includes a calibration block fixedly disposed in a welding station, and in the first direction, an upper surface of the calibration block is at a preset check distance from a preset check position; the controller is further configured to: send a check instruction to the robot; obtain a third ranging value that is obtained by the rangefinder through ranging of the upper surface of the calibration block; determine a check result for the rangefinder based on the third ranging value and the check distance; and obtain the set of ranging values between the at least two posts and the rangefinder if the check result represents a check success; and the robot is further configured to: in response to the check instruction, drive the rangefinder to move, in the first direction, to the check position and then perform ranging of the upper surface of the calibration block. In this way, ranging inaccuracies caused by rangefinder loosening and/or an abnormal ranging accuracy can be reduced by checking the rangefinder using the calibration block, so that a more appropriate position adjustment amount can be determined for the laser galvanometer in the welding device, thereby further improving the welding quality of battery product.

In some embodiments, the calibration block has a plurality of steps, and in the first direction, an upper surface of each of the steps is at a preset check distance from the check position; the controller is further configured to: obtain a third set of ranging values that is obtained by the rangefinder through ranging of the upper surface of at least one of the steps; and determine a check result for the rangefinder based on the third set of ranging values and the check distance corresponding to the upper surface of each of the at least one of the steps; and the robot is further configured to: in response to the check instruction, drive the rangefinder to move, in the first direction, to the check position and then perform the ranging of the upper surface of each of the at least one of the steps. In this way, the rangefinder can be checked for the ranging accuracy thereof at a plurality of check distances using the calibration block having a plurality of steps, which can improve the accuracy of checking the rangefinder, and thus further improve the accuracy of ranging carried out by the rangefinder.

An embodiment of the present disclosure provides a spot check method for a welding system, the method including:

obtaining a set of ranging values between a rangefinder and at least two posts in a battery product to be welded, where the set of ranging values is obtained by the rangefinder through ranging of the at least two posts along a first direction after the rangefinder is calibrated based on a first position in the first direction, the first direction being parallel to an optical axis of a laser galvanometer, the first position being a position of a focal point of the laser galvanometer in the first direction, and the rangefinder being at a fixed distance from the laser galvanometer in the first direction;
determining a first offset of a welding surface of the battery product relative to the focal point based on the set of ranging values; and
determining a first position adjustment amount for the laser galvanometer in the first direction based on the first offset and a first defocus amount corresponding to a current welding process.

According to the spot check method for a welding system in the embodiments of the present disclosure, since the first offset of the welding surface of the battery product relative to the focal point of the laser galvanometer is determined based on the set of ranging values between the rangefinder and the at least two posts in the battery product, the first offset has a higher accuracy; in addition, during the process of determining the first position adjustment amount for adjusting the laser galvanometer, the first offset and the first defocus amount corresponding to the current welding process are both considered, so that a more appropriate position adjustment amount can be determined for the laser galvanometer in a welding device, resulting in a more appropriate distance between the position-adjusted laser galvanometer and the post in the battery product to be welded, thus improving the welding quality of the battery product and increasing the product yield.

In some embodiments, the determining a first offset of a welding surface of the battery product relative to the focal point based on the set of ranging values includes: determining the first offset based on a difference between a first statistical value of all ranging values in the set of ranging values and a reference distance, where the reference distance is a distance between the calibrated rangefinder and the focal point, and the first statistical value includes a midrange and/or a first statistical quantile. In this way, the first offset of the welding surface of the battery product relative to the focal point of the laser galvanometer can be determined more accurately based on a difference between the midrange of all the ranging values in the set of ranging values and the reference distance and/or the difference between the first statistical quantile of all the ranging values and the reference distance.

In some embodiments, the determining a first offset of a welding surface of the battery product relative to the focal point based on the set of ranging values includes: determining at least two post sets based on the at least two posts, each of the post sets including at least three posts, and the at least three posts in the post set corresponding to one fitting surface; for each of the post sets, determining, from the set of ranging values, post ranging values respectively corresponding to all posts in the post set, and determining, based on all the post ranging values, a second offset of the fitting surface corresponding to the post set relative to the focal point; and determining the first offset based on all second offsets. In this way, the first offset of the welding surface of the battery product relative to the focal point can be estimated more reasonably by determining the respective second offset of the fitting surface corresponding to each post set in the battery product relative to the focal point, so that a more accurate first offset is obtained.

In some embodiments, the determining the first offset based on all second offsets includes: determining the first offset based on a second statistical value of all the second offsets, where the second statistical value includes a midrange and/or a second statistical quantile. In this way, the first offset of the welding surface of the battery product relative to the focal point of the laser galvanometer can be determined more accurately based on the midrange and/or the second statistical quantile of all the second offsets.

In some embodiments, the determining, based on all the post ranging values, a second offset of the fitting surface corresponding to the post set relative to the focal point includes: determining a maximum value in all the post ranging values; determining a minimum value in all the post ranging values; and determining a difference between the maximum value and the minimum value to be the second offset of the fitting surface corresponding to the post set relative to the focal point. In this way, since the difference between the maximum value and the minimum value in all the post ranging values can well represent the fluctuation between all the post ranging values, the second offset of the fitting surface corresponding to the post set relative to the focal point can be determined more reasonably based on the difference.

In some embodiments, the determining a first position adjustment amount for the laser galvanometer in the first direction based on the first offset and a first defocus amount corresponding to a current welding process includes: determining the first position adjustment amount for the laser galvanometer in the first direction based on a difference between the first defocus amount and the first offset. In this way, a distance between the laser galvanometer adjusted based on the first position adjustment amount and each of posts to be welded can approach the first defocus amount, thereby making it possible to well satisfy the current welding process.

In some embodiments, before the obtaining a set of ranging values between a rangefinder and at least two posts in a battery product to be welded, the method further includes: selecting the at least two posts from all posts of the battery product, the at least two posts including a first number of posts selected in a length direction of the welding surface, and a second number of posts selected in a width direction of the welding surface. In this way, the first offset of the welding surface of the battery product relative to the focal point of the laser galvanometer can be determined more accurately based on the set of ranging values between the rangefinder and the at least two posts that are selected in the length direction and the width direction of the welding surface.

In some embodiments, the method further includes at least one of operations of: sending, if a target parameter meets a preset condition, a welding instruction to a robot to cause the robot to drive the position-adjusted laser galvanometer to move perpendicularly to the first direction, so as to weld the at least two posts, the target parameter including at least one of the following: the set of ranging values, the first offset, and the first position adjustment amount; and outputting prompt information if the target parameter does not meet the preset condition. In this way, the fool-proofing management and control of the target parameter can be added to the welding process of the posts, thereby making it possible to further improve the welding quality of the battery product.

In some embodiments, if the target parameter includes the set of ranging values, the preset condition includes at least one of the following: a range of all ranging values in the set of ranging values being within a preset range scope; and a first distance difference corresponding to each ranging value in the set of ranging values being within a preset first distance difference scope, where the first distance difference corresponding to the ranging value is a distance difference between the ranging value and a reference distance, and the reference distance is a distance between the calibrated rangefinder and the focal point; if the target parameter includes the first offset, the preset condition includes: the first offset being within a preset offset scope; and if the target parameter includes the first position adjustment amount, the preset condition includes: the first position adjustment amount being within a preset first adjustment amount scope. In this way, management and control of the first offset, the first position adjustment amount and/or the ranging values for the posts can be well implemented.

In some embodiments, the target parameter includes the first position adjustment amount, and the preset condition includes at least one of the following: a difference between a second position adjustment amount and the first position adjustment amount being within an adjustment difference scope, and a second distance difference corresponding to each ranging value in the set of ranging values being within a preset second distance difference scope, where the second distance difference corresponding to the ranging value is a sum of a first distance difference corresponding to the ranging value and the second position adjustment amount, the first distance difference corresponding to the ranging value is a distance difference between the ranging value and a reference distance, and the reference distance is a distance between the calibrated rangefinder and the focal point; and the method further includes: obtaining a first ranging value and a second ranging value for a preset ranging point, the first ranging value being obtained by the rangefinder through ranging of the preset ranging point in the first direction before subjecting the laser galvanometer to the position adjustment in the first direction, and the second ranging value being obtained by the rangefinder through ranging of the preset ranging point in the first direction after subjecting the laser galvanometer to the position adjustment in the first direction;

and determining the second position adjustment amount based on a difference between the second ranging value and the first ranging value. In this way, the welding quality of the battery product can be further improved by performing fool-proofing management and control of the difference between the second position adjustment amount and the first position adjustment amount and/or the second distance difference corresponding to each ranging value in the set of ranging values.

In some embodiments, the preset condition includes: a second defocus amount being within a preset defocus amount scope; and the method further includes: determining the second defocus amount based on a sum of the second position adjustment amount and the first offset. In this way, the welding quality of the battery product can be further improved by performing fool-proofing management and control of the second defocus amount.

In some embodiments, the method further includes: sending a check instruction to the robot, the check instruction being used to instruct the robot to drive the rangefinder to move, in the first direction, to a preset check position and then perform ranging of an upper surface of a calibration block, the calibration block being fixedly disposed in a welding station, and the upper surface being at a preset check distance from the check position in the first direction; obtaining a third ranging value that is obtained by the rangefinder through ranging of the upper surface; and determining a check result for the rangefinder based on the third ranging value and the check distance; and the obtaining a set of ranging values between a rangefinder and at least two posts in a battery product to be welded includes: obtaining the set of ranging values between the at least two posts and the rangefinder if the check result represents a check success. In this way, ranging inaccuracies caused by rangefinder loosening and/or an abnormal ranging accuracy can be reduced, so that a more appropriate position adjustment amount can be determined for the laser galvanometer in the welding device, thereby further improving the welding quality of the battery product.

In some embodiments, the calibration block has a plurality of steps, and in the first direction, an upper surface of each of the steps is at a preset check distance from the check position; the obtaining a third ranging value that is obtained by the rangefinder through ranging of the upper surface includes: obtaining a third set of ranging values that is obtained by the rangefinder through ranging of the upper surface of at least one of the steps; and the determining a check result for the rangefinder based on the third ranging value and the check distance includes: determining the check result for the rangefinder based on the third set of ranging values and the check distance corresponding to the upper surface of each of the at least one of the steps. In this way, the rangefinder can be checked for the ranging accuracy thereof at a plurality of check distances using the calibration block having a plurality of steps, which can improve the accuracy of checking the rangefinder, and thus further improve the accuracy of ranging carried out by the rangefinder.

It should be understood that the above general descriptions and the detailed description hereinafter are merely exemplary and illustrative, and do not limit the technical solutions of the present disclosure.

### BRIEF DESCRIPTION OF THE DRAWINGS

The drawings herein are incorporated into the description and form a part of the description, and these drawings illustrate the embodiments conforming to the present disclosure and are intended to explain the technical solutions of the present disclosure together with the description.

FIG. 1 is a schematic diagram of a composition structure of a welding system according to an embodiment of the present disclosure;

FIG. 2 is a schematic diagram I of a structure of a calibration block according to an embodiment of the present disclosure;

FIG. 3 is a schematic diagram II of a structure of a calibration block according to an embodiment of the present disclosure;

FIG. 4 is a schematic diagram I of an implementation process of a spot check method for a welding system according to an embodiment of the present disclosure;

FIG. 5 is a schematic diagram II of an implementation process of a spot check method for a welding system according to an embodiment of the present disclosure; and

FIG. 6 is a schematic diagram of a distribution of at least two posts selected from a battery product for ranging in a spot check method for a welding system according to an embodiment of the present disclosure.

### DETAILED DESCRIPTION OF EMBODIMENTS

In order to make the purposes, technical solutions and advantages of the present disclosure clearer, the technical solutions of the present disclosure are further explained in detail below in conjunction with the accompanying drawings and embodiments, and the described embodiments shall not be regarded as limitations on the present disclosure. All other embodiments obtained by those of ordinary skill in the art without involving any inventive effort shall fall within the scope of protection of the present disclosure.

In the following description, the phrase “some embodiments” is involved, which describe a subset of all possible embodiments. However, it may be understood that the phrase “some embodiments” may be the same subset or different subsets of all the possible embodiments, and may be combined with each other without conflicts.

The terms “first/second/third” involved are only intended to distinguish between similar objects and do not represent a particular order of the objects. It may be understood that particular sequences or sequential orders indicated by the terms “first/second/third” may be interchanged if permitted, so that the embodiments of the present disclosure described herein can be implemented in an order other than that illustrated or described herein.

In this disclosure, the phrases “at least one of A, B, and C” and “at least one of A, B, or C” both mean only A, only B, only C, or any combination of A, B, and C.

Unless otherwise defined, all technical and scientific terms used herein have the same meanings as those commonly understood by those skilled in the art to which the present disclosure belongs. The terms used herein are merely for the purpose of describing the present disclosure, but are not intended to limit the present disclosure.

Currently, new energy batteries are increasingly widely applied in life and industry. The new energy batteries are not only used in energy storage power systems such as hydraulic power, thermal power, wind power and solar power stations, but also widely used in electric vehicles such as electric bicycles, electric motorcycles, and electric automobiles and in many fields such as aerospace. With the continuous expansion of the application field of power batteries, the market demand for the power batteries is also expanding.

In the embodiments of the present disclosure, a battery may be a battery cell. The battery cell refers to a basic unit capable of implementing mutual conversion between chemical energy and electrical energy. It can be used to form a battery module or a battery pack for use in supplying power to a power consuming apparatus. The battery cell may be a secondary battery. The secondary battery refers to a battery cell of which active materials can be activated by means of charging for reuse after the battery cell is discharged. The battery cell may be a lithium ion battery, a sodium ion battery, a sodium-lithium ion battery, a lithium metal battery, a sodium metal battery, a lithium-sulfur battery, a magnesium ion battery, a nickel-metal hydride battery, a nickel-cadmium battery, a lead accumulator, etc., which is not limited in the embodiments of the present disclosure.

The embodiments of the present disclosure are described in detail below.

Battery products are increasingly widely applied in life and industry. The battery products are not only used in energy storage power systems such as hydraulic power, thermal power, wind power and solar power stations, but also widely used in electric vehicles such as electric bicycles, electric motorcycles and electric automobiles and in many fields such as aerospace.

In a process of producing a battery product, posts of two adjacent battery cells in the battery product may be welded together through a busbar by means of a welding process, thereby implementing series and parallel electrical connections of various battery cells in the battery product. During the welding of the posts, due to an inappropriate distance between a laser galvanometer and a post in the battery product to be welded, it may lead to a poor welding quality, affecting a product yield. In some related technologies, the position of the laser galvanometer can be adjusted to compensate for a deviation in the distance between the laser galvanometer and the post in the battery product to be welded, i.e., to perform a defocus amount compensation for the laser galvanometer. However, it is difficult to accurately determine a position adjustment amount for the laser galvanometer in the related technologies, resulting in an imprecise defocus amount compensation, thus affecting a product quality.

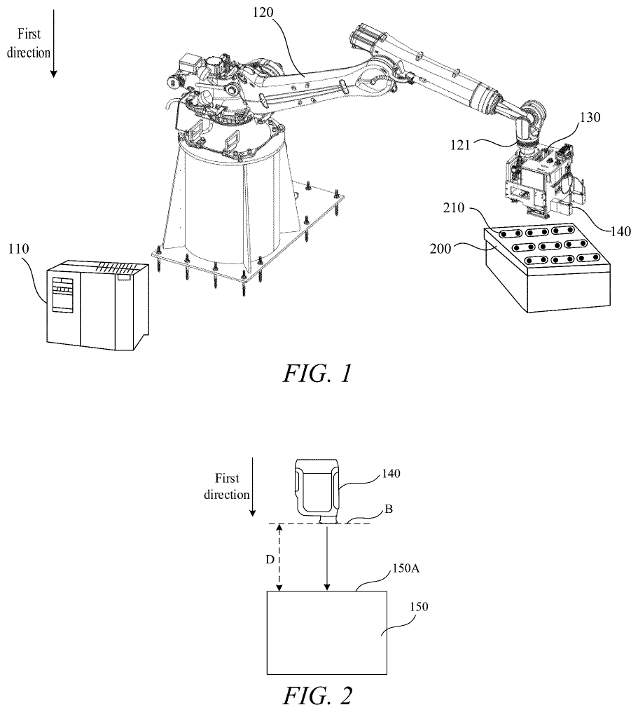

An embodiment of the present disclosure provides a welding system for use in a welding operation during a process of producing a battery product. FIG. 1 is a schematic diagram of a composition structure of a welding system according to an embodiment of the present disclosure. As shown in FIG. 1, the welding system includes: a controller 110, a robot 120, a laser galvanometer 130, and a rangefinder 140.

The rangefinder 140 and the laser galvanometer 130 are both connected to a drive end 121 of the robot 120 in a driven manner, and the rangefinder 140 is at a fixed distance from the laser galvanometer 130 in a first direction, the first direction being parallel to an optical axis of the laser galvanometer 130.

The robot 120 is configured to drive the rangefinder 140 to perform ranging, along the first direction, of at least two posts 210 in a battery product 200 to be welded, so as to obtain a set of ranging values between the at least two posts 210 and the rangefinder 140; and the rangefinder 140 is calibrated based on a first position in the first direction, the first position being a position of a focal point of the laser galvanometer 130 in the first direction.

The controller 110 is configured to: determine a first offset of a welding surface of the battery product 200 relative to the focal point based on the set of ranging values; and determine a first position adjustment amount for the laser galvanometer 130 in the first direction based on the first offset and a first defocus amount corresponding to a current welding process.

The robot 120 is further configured to: drive, based on the first position adjustment amount, the laser galvanometer 130 to be subjected to a position adjustment in the first direction; and drive the position-adjusted laser galvanometer 130 to move perpendicularly to the first direction, so as to weld the at least two posts 210.

Herein, the battery product may include a plurality of battery cells, and each battery cell may have a positive post and a negative post. For example, the battery cell may be referred to as a cell.

In some implementations, the battery product may be a battery module composed of a plurality of battery cells. For example, the battery module may be a new energy power battery module.

In some implementations, the battery product may be a battery pack composed of a plurality of battery cells or battery modules. For example, the battery pack may be a new energy power battery pack.

During implementation, those skilled in the art may employ any appropriate rangefinder according to an actual situation, which is not limited in the embodiments of the present disclosure. In some implementations, the rangefinder may be a laser rangefinder.

It may be understood that, the laser galvanometer 130 and the rangefinder 140, as a whole, may be connected to the drive end 121 of the robot 120 in a driven manner. In this way, the robot 120 can drive the laser galvanometer 130 and the rangefinder 140 to move synchronously, and the rangefinder 140 is thus at a fixed distance from the laser galvanometer 130 in the first direction.

The robot 120 can drive the rangefinder 140 to move, perpendicularly to the first direction, to a position directly facing a post along the first direction, and control the rangefinder 140 to perform ranging of the post at this position along the first direction, so as to obtain a ranging value between the post and the rangefinder 140. As such, the set of ranging values between the at least two posts and the rangefinder 140 can be obtained by sequentially performing ranging of the at least two posts 210 in the battery product 200 to be welded.

In some implementations, the first direction may be a direction that is parallel to the optical axis of the laser galvanometer 130 and directed from the rangefinder 140 toward an upper surface of the battery product 200. For example, the rangefinder 140 and the laser galvanometer 130 are located above the battery product 200, and the first direction may be a vertical downward direction.

Prior to the ranging of the post, the rangefinder 140 can be calibrated based on the position of the focal point of the laser galvanometer 130 in the first direction. During implementation, the rangefinder 140 can be calibrated in advance using a qualified battery product, and with the focal point of the laser galvanometer 130 being aligned with a post in the qualified battery product, a distance between the post and the rangefinder 140 is measured and then used as a reference distance, i.e., a distance between the calibrated rangefinder 140 and the focal point of the laser galvanometer 130.

During implementation, the controller 110 can determine the first offset of the welding surface of the battery product 200 relative to the focal point based on the set of ranging values in any suitable manner, which is not limited in the embodiments of the present disclosure. The welding surface of the battery product 200 refers to a plane formed by an upper end of each post 210 in the battery product 200. As there may be a height difference between the posts 210 in the battery product 200, and the battery product 200 itself may also be tilted, the welding surface of the battery product 200 may have a certain first offset relative to the focal point of the laser galvanometer 130. The first offset of the welding surface of the battery product 200 relative to the focal point may be estimated based on the set of ranging values for the at least two posts 210 in the battery product 200, so as to obtain the estimated first offset.

In some implementations, the first offset may be determined based on a difference between a first statistical value of all ranging values in the set of ranging values and the reference distance, where the reference distance is a distance between the calibrated rangefinder and the focal point, and the first statistical value includes a midrange and/or a first statistical quantile.

The first defocus amount corresponding to the current process refers to a distance between the focal point of the laser galvanometer 130 and the welding surface of the battery product 200 to be welded that is required to meet a requirement of the current process. During implementation, the first defocus amount corresponding to the current process can be preset according to an actual situation, which is not limited in the embodiments of the present disclosure.

After the controller 110 determines the first position adjustment amount for the laser galvanometer 130 in the first direction, the robot 120 can drive the laser galvanometer 130 to be subjected to the position adjustment in the first direction based on the first position adjustment amount, so that a distance between the focal point of the position-adjusted laser galvanometer 130 and the welding surface of the battery product 200 to be welded meets the requirement of the current process. The first position adjustment amount may be a positive value, may be a negative value, or may be zero.

After driving the laser galvanometer 130 to be subjected to the position adjustment in the first direction based on the first position adjustment amount, the robot 120 may also drive the position-adjusted laser galvanometer 130 to move, perpendicularly to the first direction, to a position directly above the posts 210 of the battery product 200 to be welded, so as to weld the posts 210. It may be understood that, the position of the laser galvanometer 130 in the first direction is always kept unchanged during a process in which the robot 120 drives the position-adjusted laser galvanometer 130 to weld the at least two posts 210 in the battery product 200 to be welded.

In this embodiment of the present disclosure, the set of ranging values between the rangefinder and the at least two posts in the battery product to be welded is obtained, where the set of ranging values is obtained by the rangefinder through ranging of the at least two posts along a first direction after the rangefinder is calibrated based on a first position in the first direction, the first direction being parallel to an optical axis of a laser galvanometer, the first position being a position of a focal point of the laser galvanometer in the first direction, and the rangefinder being at a fixed distance from the laser galvanometer in the first direction; the first offset of the welding surface of the battery product relative to the focal point is determined based on the set of ranging values; and the first position adjustment amount for the laser galvanometer in the first direction is determined based on the first offset and the first defocus amount corresponding to the current welding process. In this way, since the first offset of the welding surface of the battery product relative to the focal point of the laser galvanometer is determined based on the set of ranging values between the rangefinder and the at least two posts in the battery product, the first offset has a higher accuracy; in addition, during the process of determining the first position adjustment amount for adjusting the laser galvanometer, the first offset and the first defocus amount corresponding to the current welding process are both considered, so that a more appropriate position adjustment amount can be determined for the laser galvanometer in a welding device, resulting in a more appropriate distance between the position-adjusted laser galvanometer and the post in the battery product to be welded, thus improving the welding quality of the battery product and increasing the product yield.

In some embodiments, the controller 110 is further configured to perform at least one of operations of:

sending, if a target parameter meets a preset condition, a welding instruction to the robot 120 to cause the robot 120 to drive the position-adjusted laser galvanometer 130 to move perpendicularly to the first direction, so as to weld the at least two posts 210, the target parameter including at least one of the following: the set of ranging values, the first offset, and the first position adjustment amount; and
outputting prompt information if the target parameter does not meet the preset condition.

The preset condition may be any preset appropriate condition for fool-proofing management and control of a value of the target parameter, which is not limited in the embodiments of the present disclosure.

In some implementations, if the target parameter includes the set of ranging values, the preset condition may include, but is not limited to, at least one of the following: each ranging value in the set of ranging values being within a preset ranging value scope, a range of all ranging values in the set of ranging values being within a preset range scope, an average of all the ranging values in the set of ranging values being within a preset average scope, etc.

In some implementations, if the target parameter includes the first offset, the preset condition may include, but is not limited to, the first offset of the welding surface of the battery product 200 relative to the focal point being within a preset offset scope.

In some implementations, if the target parameter includes the first position adjustment amount, the preset condition may include, but is not limited to, the first position adjustment amount being within a preset first adjustment amount scope.

The prompt information may be any appropriate information for providing an operator with a prompt that the current target parameter does not meet the preset condition. After being informed of the prompt information, the operator may perform a manual intervention to check whether there is a large deviation in a placement position of the battery product 200 to be welded and/or the battery cell in the battery product 200, or to make a manual adjustment to the placement position of the battery product 200 to be welded and/or the battery cell in the battery product 200, etc., so that a target parameter determined after the adjustment meets the preset condition.

In the above embodiment, if the target parameter meets the preset condition, the welding instruction is sent to the robot to cause the robot to drive the position-adjusted laser galvanometer to move perpendicularly to the first direction, so as to weld the at least two posts; and the prompt information is output if the target parameter does not meet the preset condition. In this way, the fool-proofing management and control of the target parameter can be added to the welding process of the posts, thereby making it possible to further improve the welding quality of the battery product.

In some embodiments, if the target parameter includes the set of ranging values, the preset condition includes at least one of the following: a range of all ranging values in the set of ranging values being within a preset range scope; and a first distance difference corresponding to each ranging value in the set of ranging values being within a preset first distance difference scope, where the first distance difference corresponding to the ranging value is a distance difference between the ranging value and a reference distance, and the reference distance is a distance between the calibrated rangefinder and the focal point.

In some embodiments, if the target parameter includes the first offset, the preset condition includes: the first offset being within a preset offset scope.

In some embodiments, if the target parameter includes the first position adjustment amount, the preset condition includes: the first position adjustment amount being within a preset first adjustment amount scope.

During implementation, the above range scope, first distance difference scope, offset scope, and first adjustment amount scope can all be preset by those skilled in the art according to an actual situation, which are not limited in the embodiments of the present disclosure.

In some embodiments, the target parameter includes the first position adjustment amount, and the preset condition includes at least one of the following: a difference between a second position adjustment amount and the first position adjustment amount being within an adjustment difference scope, and a second distance difference corresponding to each ranging value in the set of ranging values being within a preset second distance difference scope, where the second distance difference corresponding to the ranging value is a sum of a first distance difference corresponding to the ranging value and the second position adjustment amount.

The robot 120 is further configured to: before subjecting the laser galvanometer 130 to the position adjustment in the first direction, drive the rangefinder 140 to perform ranging, along the first direction, of a preset ranging point, so as to obtain a first ranging value; and after subjecting the laser galvanometer 130 to the position adjustment in the first direction, drive the rangefinder 140 to perform ranging, along the first direction, of the preset ranging point, so as to obtain a second ranging value.

The controller 110 is further configured to determine the second position adjustment amount based on a difference between the second ranging value and the first ranging value.

Herein, the first distance difference for a post is a distance difference between the ranging value corresponding to the post and the reference distance, i.e., a theoretical distance offset of the post relative to the focal point of the laser galvanometer 130.

It may be understood that, there may be a control error in the process in which the robot 120 drives the laser galvanometer 130 to be subjected to the position adjustment in the first direction based on the first position adjustment amount, resulting in an adjustment difference between the first position adjustment amount and an actual amount of movement of the laser galvanometer 130 in the first direction that is caused by the position adjustment of the laser galvanometer 130 in the first direction.

The preset ranging point may be a ranging point that is fixed in a welding station. The first ranging value is obtained by the rangefinder 140 through the ranging, along the first direction, of the preset ranging point before the position adjustment of the laser galvanometer 130 in the first direction, the second ranging value is obtained by the rangefinder 140 through the ranging, along the first direction, of the preset ranging point after the position adjustment of the laser galvanometer 130 in the first direction, and the second position adjustment amount is determined based on the difference between the second ranging value and the first ranging value. Therefore, the second position adjustment amount can represent an actual amount of movement of the laser galvanometer 130 in the first direction that is caused by the position adjustment of the laser galvanometer 130 in the first direction. In addition, since the rangefinder 140 is at a fixed distance from the laser galvanometer 130 in the first direction, the second position adjustment amount also represents the actual amount of movement of the laser galvanometer 130 in the first direction that is caused by the position adjustment of the laser galvanometer 130 in the first direction. Thus, a difference between the second position adjustment amount and the first position adjustment amount can represent the adjustment difference between the first position adjustment amount and the actual amount of movement of the laser galvanometer 130 in the first direction that is caused by the position adjustment of the laser galvanometer 130 in the first direction; and the sum of the first distance difference for a post and the second position adjustment amount can represent an actual distance offset of the post relative to the focal point of the laser galvanometer 130. In this way, the welding quality of the battery product can be further improved by performing fool-proofing management and control of the adjustment difference and/or the actual distance offset corresponding to each post.

During implementation, the adjustment difference scope and the second distance difference scope can both be preset by those skilled in the art according to an actual situation, which are not limited in the embodiments of the present disclosure.

In some implementations, the adjustment difference scope is ±0.2 millimeters (mm).

In some embodiments, referring to FIG. 2, the welding system further includes a calibration block 150 fixedly disposed in the welding station. In the first direction, an upper surface 150A of the calibration block 150 is at a preset check distance D from a preset check position B.

The controller 110 is further configured to: send a check instruction to the robot 120; obtain a third ranging value that is obtained by the rangefinder 140 through ranging of the upper surface 150A of the calibration block 150; determine a check result for the rangefinder 140 based on the third ranging value and the check distance; and obtain the set of ranging values between the at least two posts and the rangefinder 140 if the check result represents a check success.

The robot 120 is further configured to: in response to the check instruction, drive the rangefinder 140 to move, in the first direction, to the check position B and then perform ranging of the upper surface 150A of the calibration block 150.

The calibration block can be fixedly disposed at any appropriate position in the welding station. The check position B may be any preset appropriate position in the first direction. After the check position B and the check distance D are determined, the position of the calibration block remains unchanged. If the position of the calibration block changes, a recalibration is required to determine the check distance D between the upper surface 150A of the calibration block 150 and the preset check position B.

The position of the calibration block 150 can be determined according to an actual situation, which is not limited in the embodiments of the present disclosure. For example, the calibration block 150 can be disposed near an edge in the welding station.

In some implementations, the calibration block 150 can be fixed and clamped by a fixture that is fixed in the station.

It may be understood that, the third ranging value is a distance, in the first direction, between the upper surface 150A of the calibration block 150 and the check position B that is measured by the rangefinder 140, and the check distance is an actual distance, in the first direction, between the upper surface 150A of the calibration block 150 and the check position B. Through a comparison between the third ranging value and the check distance, the rangefinder can be checked for the positional stability and/or ranging accuracy, etc. thereof. For example, if a difference between the third ranging value and the check distance is within a preset check difference scope, it can be determined that the check of the rangefinder 140 succeeds; and if the difference between the third ranging value and the check distance exceeds the check difference scope, it can be determined that the check of the rangefinder 140 fails. For example, the check difference scope may be ±0.2 mm.

During implementation, the controller 110 may send the check instruction to the robot 120 prior to welding of posts in each battery product, so as to check the rangefinder using the calibration block, or the controller 110 may send the check instruction to the robot 120 prior to each operation, so as to check the rangefinder using the calibration block, which is not limited in the embodiments of the present disclosure.

If the check result represents the check success, the controller 110 may send a ranging instruction to the robot 120 to cause the robot 120 to, in response to the ranging instruction, drive the rangefinder 140 to perform the ranging, along the first direction, of the at least two posts 210 in the battery product 200 to be welded, so as to obtain the set of ranging values for the at least two posts 210.

In some implementations, the check of the rangefinder 140 may be repeated a preset number of times, and the controller 110 may obtain the set of ranging values between the at least two posts and the rangefinder 140 if results of the preset number of checks each represent a check success. For example, the preset number of times may be 5, 10, or 15, etc.

In the above embodiment, prior to obtaining the set of ranging values between the rangefinder and the at least two posts in the battery product to be welded, the rangefinder is checked using the calibration block fixedly disposed in the welding station, and the set of ranging values between the at least two posts and the rangefinder is obtained if the check result represents the check success. In this way, ranging inaccuracies caused by rangefinder loosening and/or an abnormal ranging accuracy can be reduced, so that a more appropriate position adjustment amount can be determined for the laser galvanometer in the welding device, thereby further improving the welding quality of the battery product.

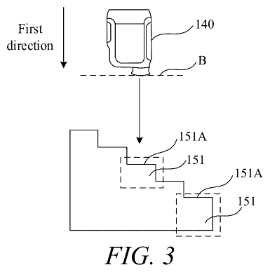

In some embodiments, referring to FIG. 3, the calibration block 150 has a plurality of steps 151, and in the first direction, an upper surface 151A of each step 151 is at a preset check distance from the check position B.

The controller 110 is further configured to: obtain a third set of ranging values that is obtained by the rangefinder 140 through ranging of the upper surface 151A of at least one step 151; and determine a check result for the rangefinder 140 based on the third set of ranging values and the respective check distance corresponding to the upper surface 151A of the at least one step 151.

The robot 120 is further configured to: in response to the check instruction, drive the rangefinder 140 to move, in the first direction, to the check position and then perform ranging of the upper surface 151A of each of the at least one step 151.

During implementation, the upper surface 151A of each step 151 is at a corresponding check distance from the check position. For the upper surface 151A of each step 151, the robot can drive the rangefinder to move to a position directly above the step 151 and at the check position in the first direction, so as to perform ranging of the upper surface 151A of the step 151.

In some implementations, all the steps 151 of the calibration block may have the same height. For example, the calibration block 150 has five steps 151, and each step may have a height of 2 mm, where upper surfaces 151A of the five steps 151 may respectively correspond to check distances of −4 mm, −2 mm, 0 mm, 2 mm, and 4 mm.

In some implementations, all the steps 151 of the calibration block may have different heights.

In the above embodiment, the rangefinder can be checked for the ranging accuracy thereof at a plurality of check distances using the calibration block having a plurality of steps, which can improve the accuracy of checking the rangefinder, and thus further improve the accuracy of ranging carried out by the rangefinder.

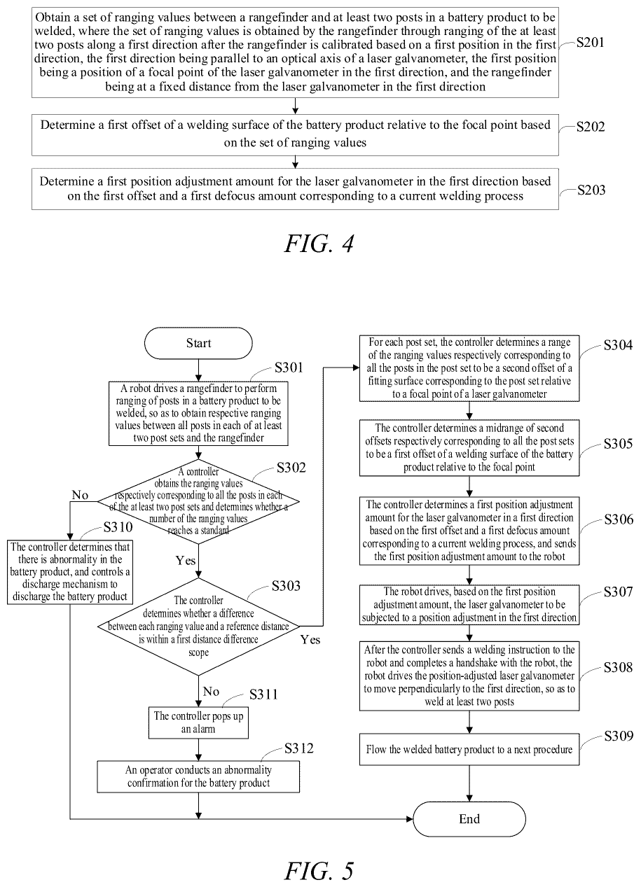

Based on the above welding system provided in this embodiment of the present disclosure, an embodiment of the present disclosure provides a spot check method for a welding system, which method can be performed by the controller 110 in the welding system. During implementation, the controller 110 may be, for example, an industrial personal computer, a programmable logic controller (PLC), etc. FIG. 4 is a schematic diagram I of an implementation process of a spot check method for a welding system according to an embodiment of the present disclosure. As shown in FIG. 4, the method may include steps S201 to S203 below.

Step S201: Obtain a set of ranging values between a rangefinder and at least two posts in a battery product to be welded, where the set of ranging values is obtained by the rangefinder through ranging of the at least two posts along a first direction after the rangefinder is calibrated based on a first position in the first direction, the first direction being parallel to an optical axis of a laser galvanometer, the first position being a position of a focal point of the laser galvanometer in the first direction, and the rangefinder being at a fixed distance from the laser galvanometer in the first direction.

Step S202: Determine a first offset of a welding surface of the battery product relative to the focal point based on the set of ranging values.

Step S203: Determine a first position adjustment amount for the laser galvanometer in the first direction based on the first offset and a first defocus amount corresponding to a current welding process.

In some implementations, the first position adjustment amount for the laser galvanometer in the first direction can be determined based on a difference between the first defocus amount and the first offset. In this way, a distance between the laser galvanometer adjusted based on the first position adjustment amount and each of posts to be welded can approach the first defocus amount, thereby making it possible to well satisfy the current welding process.

In this embodiment of the present disclosure, the set of ranging values between the rangefinder and the at least two posts in the battery product to be welded is obtained, where the set of ranging values is obtained by the rangefinder through ranging of the at least two posts along a first direction after the rangefinder is calibrated based on a first position in the first direction, the first direction being parallel to an optical axis of a laser galvanometer, the first position being a position of a focal point of the laser galvanometer in the first direction, and the rangefinder being at a fixed distance from the laser galvanometer in the first direction; the first offset of the welding surface of the battery product relative to the focal point is determined based on the set of ranging values; and the first position adjustment amount for the laser galvanometer in the first direction is determined based on the first offset and the first defocus amount corresponding to the current welding process. In this way, since the first offset of the welding surface of the battery product relative to the focal point of the laser galvanometer is determined based on the set of ranging values between the rangefinder and the at least two posts in the battery product, the first offset has a higher accuracy; in addition, during the process of determining the first position adjustment amount for adjusting the laser galvanometer, the first offset and the first defocus amount corresponding to the current welding process are both considered, so that a more appropriate position adjustment amount can be determined for the laser galvanometer in a welding device, resulting in a more appropriate distance between the position-adjusted laser galvanometer and the post in the battery product to be welded, thus improving the welding quality of the battery product and increasing the product yield.

In some embodiments, step S202 above may include: determining the first offset based on a difference between a first statistical value of all ranging values in the set of ranging values and a reference distance, where the reference distance is a distance between the calibrated rangefinder and the focal point, and the first statistical value includes a midrange and/or a first statistical quantile. Herein, the first statistical quantile may include, but is not limited to, a quartile, a quintile, or an octile, etc. The midrange refers to a value obtained by averaging a maximum value and a minimum value.

In the above embodiment, the first offset of the welding surface of the battery product relative to the focal point of the laser galvanometer can be determined more accurately based on a difference between the midrange of all the ranging values in the set of ranging values and the reference distance and/or the difference between the first statistical quantile of all the ranging values and the reference distance.

In some embodiments, step S202 above may include steps S211 to S213 below.

Step S211: Determine at least two post sets based on the at least two posts, each of the post sets including at least three posts, and the at least three posts in the post set corresponding to one fitting surface.

Herein, the at least two post sets may be formed by selection from the at least two posts in any suitable manner, which is not limited in the embodiments of the present disclosure.

During implementation, all the posts in the post set can be fitted into one surface, i.e., the fitting surface corresponding to the post set.

In some implementations, fitting surfaces respectively corresponding to all the post sets may cover an upper surface of the battery product.

Step S212: For each of the post sets, determine, from the set of ranging values, post ranging values respectively corresponding to all posts in the post set, and determine, based on all the post ranging values, a second offset of the fitting surface corresponding to the post set relative to the focal point.

Herein, the second offset of the fitting surface corresponding to the post set relative to the focal point can be determined based on the post ranging values respectively corresponding to all the posts in the post set in any suitable manner, which is not limited in the embodiments of the present disclosure.

In some implementations, a surface ranging value for the fitting surface corresponding to the post set can be determined based on the post ranging values respectively corresponding to all the posts in the post set, and the second offset of the fitting surface relative to the focal point can be determined based on a difference between the surface ranging value and the reference distance. For example, a maximum value in the post ranging values respectively corresponding to all the posts in the post set may be determined as the surface ranging value for the fitting surface corresponding to the post set, or a minimum value in the post ranging values respectively corresponding to all the posts in the post set may be determined as the surface ranging value for the fitting surface corresponding to the post set, or an average of the maximum value and the maximum value in the post ranging values respectively corresponding to all the posts in the post set may be determined as the surface ranging value for the fitting surface corresponding to the post set.

In some implementations, a third statistical value of the post ranging values respectively corresponding to all the posts in the post set may be determined to be the second offset of the fitting surface corresponding to the post set relative to the focal point. The third statistical value may include, but is not limited to, at least one of a range, a variance, etc. Step S213: Determine the first offset based on all second offsets.

During implementation, the first offset can be determined based on all the second offsets in any suitable manner, which is not limited in the embodiments of the present disclosure.

For example, a maximum value, a minimum value, an average, a median, or a mode, etc. in all the second offsets may be determined as the first offset.

In the above embodiment, the at least two post sets are determined based on the at least two posts, each of the post sets including at least three posts, and the at least three posts in the post set corresponding to one fitting surface; for each post set, the post ranging values respectively corresponding to all the posts in the post set are determined from the set of ranging values, and the second offset of the fitting surface corresponding to the post set relative to the focal point is determined based on all the post ranging values; and the first offset is determined based on all the second offsets. In this way, the first offset of the welding surface of the battery product relative to the focal point can be estimated more reasonably by determining the respective second offset of the fitting surface corresponding to each post set in the battery product relative to the focal point, so that a more accurate first offset is obtained.

In some embodiments, step S213 above may include: determining the first offset based on a second statistical value of all the second offsets, where the second statistical value includes a midrange and/or a second statistical quantile.

Herein, the second statistical quantile may include, but is not limited to, a quartile, a quintile, or an octile, etc.

In the above embodiment, the first offset of the welding surface of the battery product relative to the focal point of the laser galvanometer can be determined more accurately based on the midrange and/or the second statistical quantile of all the second offsets.

In some embodiments, the determining, based on all the post ranging values, a second offset of the fitting surface corresponding to the post set relative to the focal point in step S212 may include steps S221 to S223 below.

Step S221: Determine the maximum value in all the post ranging values.

Step S222: Determine the minimum value in all the post ranging values.

Step S223: Determine a difference between the maximum value and the minimum value to be the second offset of the fitting surface corresponding to the post set relative to the focal point.

In this way, since the difference between the maximum value and the minimum value in all the post ranging values can well represent the fluctuation between all the post ranging values, the second offset of the fitting surface corresponding to the post set relative to the focal point can be determined more reasonably based on the difference.

In some embodiments, before step S201 above, the method may further include: selecting the at least two posts from all posts of the battery product, the at least two posts including a first number of posts selected in a length direction of the welding surface, and a second number of posts selected in a width direction of the welding surface.

During implementation, each of the first number and the second number may be any suitable number determined according to an actual situation, which is not limited in the embodiments of the present disclosure.

In this way, the first offset of the welding surface of the battery product relative to the focal point of the laser galvanometer can be determined more accurately based on the set of ranging values between the rangefinder and the at least two posts that are selected in the length direction and the width direction of the welding surface.

In some embodiments, the method further includes at least one of steps S231 and S232 below.

Step S231: Send, if a target parameter meets a preset condition, a welding instruction to a robot to cause the robot to drive the position-adjusted laser galvanometer to move perpendicularly to the first direction, so as to weld the at least two posts, the target parameter including at least one of the following: the set of ranging values, the first offset, and the first position adjustment amount.

Step S232: Output prompt information if the target parameter does not meet the preset condition.

In the above embodiment, if the target parameter meets the preset condition, the welding instruction is sent to the robot to cause the robot to drive the position-adjusted laser galvanometer to move perpendicularly to the first direction, so as to weld the at least two posts; and the prompt information is output if the target parameter does not meet the preset condition. In this way, the fool-proofing management and control of the target parameter can be added to the welding process of the posts, thereby making it possible to further improve the welding quality of the battery product.

In some embodiments, if the target parameter includes the set of ranging values, the preset condition includes at least one of the following: a range of all ranging values in the set of ranging values being within a preset range scope; and a first distance difference corresponding to each ranging value in the set of ranging values being within a preset first distance difference scope, where the first distance difference corresponding to the ranging value is a distance difference between the ranging value and a reference distance, and the reference distance is a distance between the calibrated rangefinder and the focal point;

if the target parameter includes the first offset, the preset condition includes: the first offset being within a preset offset scope; and
if the target parameter includes the first position adjustment amount, the preset condition includes: the first position adjustment amount being within a preset first adjustment amount scope.

In this way, management and control of the first offset, the first position adjustment amount and/or the ranging values for the posts can be well implemented.

In some embodiments, the target parameter includes the first position adjustment amount, and the preset condition includes at least one of the following: a difference between a second position adjustment amount and the first position adjustment amount being within an adjustment difference scope, and a second distance difference corresponding to each ranging value in the set of ranging values being within a preset second distance difference scope, where the second distance difference corresponding to the ranging value is a sum of a first distance difference corresponding to the ranging value and the second position adjustment amount.

The method may further include steps S241 and S242 below.

Step S241: Obtain a first ranging value and a second ranging value for a preset ranging point, the first ranging value being obtained by the rangefinder through ranging of the preset ranging point in the first direction before subjecting the laser galvanometer to the position adjustment in the first direction, and the second ranging value being obtained by the rangefinder through ranging of the preset ranging point in the first direction after subjecting the laser galvanometer to the position adjustment in the first direction.

Step S242: Determine the second position adjustment amount based on a difference between the second ranging value and the first ranging value.

In this way, the welding quality of the battery product can be further improved by performing fool-proofing management and control of the difference between the second position adjustment amount and the first position adjustment amount and/or the second distance difference corresponding to each ranging value in the set of ranging values.

In some embodiments, the preset condition includes: a second defocus amount being within a preset defocus amount scope. The method further includes step S251 below.

Step S251: Determine the second defocus amount based on a sum of the second position adjustment amount and the first offset.

Herein, since the second position adjustment amount represents an actual amount of movement of the laser galvanometer in the first direction that is caused by the position adjustment of the laser galvanometer in the first direction, the sum of the second position adjustment amount and the first offset can represent an actual offset of the welding surface of the battery product relative to the focal point after the position adjustment of the laser galvanometer in the first direction, i.e., the second defocus amount. In this way, the welding quality of the battery product can be further improved by performing fool-proofing management and control of the second defocus amount.

During implementation, the defocus amount scope can be preset by those skilled in the art according to an actual situation, which is not limited in the embodiments of the present disclosure.

In some embodiments, the method may further include steps S261 to S263 below.

Step S261: Send a check instruction to the robot, the check instruction being used to instruct the robot to drive the rangefinder to move, in the first direction, to a preset check position and then perform ranging of an upper surface of a calibration block, the calibration block being fixedly disposed in a welding station, and the upper surface being at a preset check distance from the check position in the first direction.

Step S262: Obtain a third ranging value that is obtained by the rangefinder through ranging of the upper surface.

Step S263: Determine a check result for the rangefinder based on the third ranging value and the check distance.

Step S201 above may include step S264 below.

Step S264: Obtain the set of ranging values between the at least two posts and the rangefinder if the check result represents a check success.

In the above embodiment, prior to obtaining the set of ranging values between the rangefinder and the at least two posts in the battery product to be welded, the rangefinder is checked using the calibration block fixedly disposed in the welding station, and the set of ranging values between the at least two posts and the rangefinder is obtained if the check result represents the check success. In this way, ranging inaccuracies caused by rangefinder loosening and/or an abnormal ranging accuracy can be reduced, so that a more appropriate position adjustment amount can be determined for the laser galvanometer in the welding device, thereby further improving the welding quality of the battery product.

In some embodiments, the calibration block has a plurality of steps, and in the first direction, an upper surface of each of the steps is at a preset check distance from the check position. Step S262 above may include step S271 below.

Step S271: Obtain a third set of ranging values that is obtained by the rangefinder through ranging of the upper surface of at least one of the steps.

Step S263 above may include step S272 below.

Step S272: Determine the check result for the rangefinder based on the third set of ranging values and the check distance corresponding to the upper surface of each of the at least one of the steps.

In the above embodiment, the rangefinder can be checked for the ranging accuracy thereof at a plurality of check distances using the calibration block having a plurality of steps, which can improve the accuracy of checking the rangefinder, and thus further improve the accuracy of ranging carried out by the rangefinder.

The application of the embodiments of the present disclosure in an actual scenario is described below.

The embodiments of the present disclosure provide a spot check method for a welding system. FIG. 5 is a schematic diagram II of an implementation process of a spot check method for a welding system according to an embodiment of the present disclosure. As shown in FIG. 5, the method may include steps S301 to S312 below.

Step S301: A robot drives a rangefinder to perform ranging of posts in a battery product to be welded, so as to obtain respective ranging values between all posts in each of at least two post sets and the rangefinder.

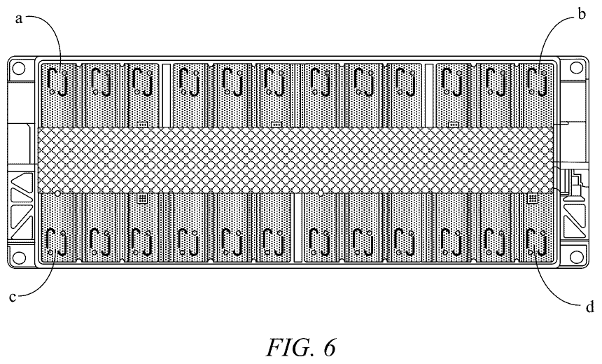

In some implementations, as shown in FIG. 6, posts a, b, c, and d in the battery product may be selected for ranging, and the at least two post sets may include a first post set and a second post set, the first post set including posts a, b, and c, and the second post set including posts b, c, and d.

Step S302: A controller obtains the ranging values respectively corresponding to all the posts in each of the at least two post sets and determines whether a number of the ranging values reaches a standard; and if so, the process proceeds to step S303; otherwise, the process proceeds to step S310.

It may be understood that, the fact that the number of the ranging values respectively corresponding to all the posts in the post set reaches the standard means that the number of the currently obtained ranging values respectively corresponding to all the posts in the post set is equal to a number of all the posts in the post set, that is to say, a ranging value for each post in the post set is obtained.

Step S303: The controller determines whether a difference between each ranging value and a reference distance is within a first distance difference scope; and if so, the process proceeds to step S304; otherwise, the process proceeds to step S311.

For example, the first distance difference scope may be ±2 mm.

Step S304: For each post set, the controller determines a range of the ranging values respectively corresponding to all the posts in the post set to be a second offset of a fitting surface corresponding to the post set relative to a focal point of a laser galvanometer.

Step S305: The controller determines a midrange of second offsets respectively corresponding to all the post sets to be a first offset of a welding surface of the battery product relative to the focal point.

Step S306: The controller determines a first position adjustment amount for the laser galvanometer in a first direction based on the first offset and a first defocus amount corresponding to a current welding process, and sends the first position adjustment amount to the robot.

Step S307: The robot drives, based on the first position adjustment amount, the laser galvanometer to be subjected to a position adjustment in the first direction.

Step S308: After the controller sends a welding instruction to the robot and completes a handshake with the robot, the robot drives the position-adjusted laser galvanometer to move perpendicularly to the first direction, so as to weld at least two posts.

Step S309: Flow the welded battery product to a next procedure.

Herein, after the welding is completed, the welded battery product may be flowed to the next procedure by an unloading mechanism under the control of the controller, or the welded battery product may be flowed to the next procedure by an operator manually, which is not limited in the embodiments of the present disclosure.

Step S310: The controller determines that there is abnormality in the battery product, and controls a discharge mechanism to discharge the battery product. Step S311: The controller pops up an alarm.

Step S312: An operator conducts an abnormality confirmation for the battery product.

It may be understood that, in some implementations, after the welding is completed, the robot can drive the rangefinder and the laser galvanometer to move to a preset initial position to initialize a ranging value from the rangefinder.

According to the spot check method for a welding system provided in the embodiments of the present disclosure, the stability of welding penetration can be improved, and the probability of weak welding and pseudo welding can be reduced, thereby improving the welding quality of the battery product and increasing the product yield.

It should be noted herein that the above descriptions of the embodiments tend to emphasize differences between the embodiments, and for the same or similar parts of the embodiments, reference may be made between the embodiments.

It should be understood that, the phrase “one embodiment” or “an embodiment” mentioned throughout the description means that particular features, structures, or characteristics related to the embodiment are included in at least one embodiment of the present disclosure. Therefore, the phrase “in one embodiment” or “in an embodiment” presented everywhere throughout the description does not necessarily refer to the same embodiment. Furthermore, these particular features, structures, or characteristics may be combined into one or more embodiments in any suitable manner. It should be understood that, in the embodiments of the present disclosure, sequence numbers of the foregoing steps/processes do not indicate an execution sequence. The execution sequence of the steps/processes should be determined according to functions and internal logic of the steps/processes, and should not be construed as any limitation on the implementation processes of the embodiments of the present disclosure. The sequence numbers of the above embodiments of the present disclosure are only for description, and do not represent the superiority or inferiority of the embodiments.

It should be noted that, the term “comprise”, “include” or any other variant thereof herein is intended to cover a non-exclusive inclusion, so that a process, method, article, or apparatus that includes a series of elements not only includes these elements, but also includes other elements not explicitly listed, or elements that are inherent to such a process, method, article, or apparatus. In the absence of more restrictions, an element defined by a phrase “including one . . . ” does not exclude the presence of other identical elements in a process, method, article, or apparatus that includes the element.

In the several embodiments provided in the present disclosure, it should be understood that the disclosed system and method may be implemented in other manners. For example, the division of the units is only a logical functional division, and during practical implementation, there may be another manner for division. For instance: a plurality of units or components may be combined or integrated into another system, or some features may be ignored or not performed. In addition, the displayed or discussed mutual couplings or direct couplings or communication connections between various constituent parts may be implemented through some interfaces. The indirect couplings or communication connections between controllers or units may be implemented in electrical, mechanical, or other forms.

The above units described as separate components may or may not be physically separated. The components shown as units may or may not be physical units. They may be located in one place, or may be distributed over a plurality of network units. Some or all of the units may be selected according to actual requirements to achieve the objectives of the solutions of the embodiments. In addition, all functional units in the embodiments of the present disclosure may be integrated into one processing unit, or each unit may separately serve as one unit, or two or more units may be integrated into one unit. The above integrated unit may be implemented in a form of hardware, or may be implemented in a form of hardware plus a software functional unit.

The above descriptions are merely the implementations of the present disclosure, and the scope of protection of the present disclosure is not limited thereto. Variations or replacements that may be readily conceived by any person skilled in the art within the technical scope disclosed in the present disclosure shall fall within the scope of protection of the present disclosure.

### INDUSTRIAL APPLICABILITY

According to the welding system and the spot check method for a welding system in the embodiments of the present disclosure, since the first offset of the welding surface of the battery product relative to the focal point of the laser galvanometer is determined based on the set of ranging values between the rangefinder and the at least two posts in the battery product, the first offset has a higher accuracy; in addition, during the process of determining the first position adjustment amount for adjusting the laser galvanometer, the first offset and the first defocus amount corresponding to the current welding process are both considered, so that a more appropriate position adjustment amount can be determined for the laser galvanometer in a welding device, resulting in a more appropriate distance between the position-adjusted laser galvanometer and the post in the battery product to be welded, thus improving the welding quality of the battery product and increasing the product yield.

What is claimed is:

1. A welding system, comprising: a controller, a robot, a laser galvanometer, and a rangefinder, wherein:
the rangefinder and the laser galvanometer are both connected to a drive end of the robot in a driven manner, and the rangefinder is at a fixed distance from the laser galvanometer in a first direction, the first direction being parallel to an optical axis of the laser galvanometer;
the robot is configured to drive the rangefinder to perform ranging, along the first direction, of at least two posts in a battery product to be welded, so as to obtain a set of ranging values between the at least two posts and the rangefinder;
the rangefinder is calibrated based on a first position in the first direction, the first position being a position of a focal point of the laser galvanometer in the first direction;
the controller is configured to:
determine a first offset of a welding surface of the battery product relative to the focal point based on the set of ranging values; and
determine a first position adjustment amount for the laser galvanometer in the first direction based on the first offset and a first defocus amount corresponding to a current welding process; and
the robot is further configured to:
drive, based on the first position adjustment amount, the laser galvanometer to be subjected to a position adjustment in the first direction; and
drive the position-adjusted laser galvanometer to move perpendicularly to the first direction, so as to weld the at least two posts.

2. The welding system according to claim 1, wherein the controller is further configured to perform at least one of operations of:
sending, if a target parameter meets a preset condition, a welding instruction to the robot to cause the robot to drive the position-adjusted laser galvanometer to move perpendicularly to the first direction, so as to weld the at least two posts, the target parameter comprising at least one of the following: the set of ranging values, the first offset, and the first position adjustment amount; and
outputting prompt information if the target parameter does not meet the preset condition.

3. The welding system according to claim 2, wherein:
the target parameter comprises the first position adjustment amount, and the preset condition comprises at least one of the following: a difference between a second position adjustment amount and the first position adjustment amount being within an adjustment difference scope, and a second distance difference corresponding to each ranging value in the set of ranging values being within a preset second distance difference scope, wherein the second distance difference corresponding to the ranging value is a sum of a first distance difference corresponding to the ranging value and the second position adjustment amount, the first distance difference corresponding to the ranging value is a distance difference between the ranging value and a reference distance, and the reference distance is a distance between the calibrated rangefinder and the focal point;
the robot is further configured to:
before subjecting the laser galvanometer to the position adjustment in the first direction, drive the rangefinder to perform ranging, along the first direction, of a preset ranging point, so as to obtain a first ranging value; and
after subjecting the laser galvanometer to the position adjustment in the first direction, drive the rangefinder to perform ranging, along the first direction, of the preset ranging point, so as to obtain a second ranging value; and
the controller is further configured to determine the second position adjustment amount based on a difference between the second ranging value and the first ranging value.

4. The welding system according to claim 1, wherein further comprising:
a calibration block fixedly disposed in a welding station, wherein in the first direction, an upper surface of the calibration block is at a preset check distance from a preset check position;
wherein the controller is further configured to:
send a check instruction to the robot; obtain a third ranging value that is obtained by the rangefinder through ranging of the upper surface of the calibration block;
determine a check result for the rangefinder based on the third ranging value and the check distance; and
obtain the set of ranging values between the at least two posts and the rangefinder if the check result represents a check success; and
the robot is further configured to: in response to the check instruction, drive the rangefinder to move, in the first direction, to the check position and then perform ranging of the upper surface of the calibration block.

5. The welding system according to claim 4, wherein:
the calibration block has a plurality of steps, and in the first direction, an upper surface of each of the steps is at a preset check distance from the check position;
the controller is further configured to:
obtain a third set of ranging values that is obtained by the rangefinder through ranging of the upper surface of at least one of the steps; and
determine a check result for the rangefinder based on the third set of ranging values and the check distance corresponding to the upper surface of each of the at least one of the steps; and
the robot is further configured to: in response to the check instruction, drive the rangefinder to move, in the first direction, to the check position and then perform the ranging of the upper surface of each of the at least one of the steps.

6. A spot check method for a welding system, comprising:
obtaining a set of ranging values between a rangefinder and at least two posts in a battery product to be welded, wherein the set of ranging values is obtained by the rangefinder through ranging of the at least two posts along a first direction after the rangefinder is calibrated based on a first position in the first direction, the first direction being parallel to an optical axis of a laser galvanometer, the first position being a position of a focal point of the laser galvanometer in the first direction, and the rangefinder being at a fixed distance from the laser galvanometer in the first direction;
determining a first offset of a welding surface of the battery product relative to the focal point based on the set of ranging values; and
determining a first position adjustment amount for the laser galvanometer in the first direction based on the first offset and a first defocus amount corresponding to a current welding process.

7. The spot check method according to claim 6, wherein determining the first offset of the welding surface of the battery product relative to the focal point based on the set of ranging values comprises:
determining the first offset based on a difference between a first statistical value of all ranging values in the set of ranging values and a reference distance, wherein the reference distance is a distance between the calibrated rangefinder and the focal point, and the first statistical value comprises a midrange and/or a first statistical quantile.

8. The spot check method according to claim 6, wherein determining the first offset of the welding surface of the battery product relative to the focal point based on the set of ranging values comprises:
determining at least two post sets based on the at least two posts, each of the post sets comprising at least three posts, and the at least three posts in the post set corresponding to one fitting surface;
for each of the post sets, determining, from the set of ranging values, post ranging values respectively corresponding to all posts in the post set, and determining, based on all the post ranging values, a second offset of the fitting surface corresponding to the post set relative to the focal point; and
determining the first offset based on all second offsets.

9. The spot check method according to claim 8, wherein determining the first offset based on all second offsets comprises:
determining the first offset based on a second statistical value of all the second offsets, wherein the second statistical value comprises a midrange and/or a second statistical quantile.

10. The spot check method according to claim 8, wherein determining, based on all the post ranging values, the second offset of the fitting surface corresponding to the post set relative to the focal point comprises:
determining a maximum value in all the post ranging values;
determining a minimum value in all the post ranging values; and
determining a difference between the maximum value and the minimum value to be the second offset of the fitting surface corresponding to the post set relative to the focal point.

11. The spot check method according to claim 6, wherein determining the first position adjustment amount for the laser galvanometer in the first direction based on the first offset and the first defocus amount corresponding to the current welding process comprises:
determining the first position adjustment amount for the laser galvanometer in the first direction based on a difference between the first defocus amount and the first offset.

12. The spot check method according to claim 6, further comprising, before obtaining the set of ranging values between the rangefinder and the at least two posts in the battery product to be welded:
selecting the at least two posts from all posts of the battery product, the at least two posts comprising a first number of posts selected in a length direction of the welding surface, and a second number of posts selected in a width direction of the welding surface.

13. The spot check method according to claim 6, further comprising at least one of operations of:
sending, if a target parameter meets a preset condition, a welding instruction to a robot to cause the robot to drive the position-adjusted laser galvanometer to move perpendicularly to the first direction, so as to weld the at least two posts, the target parameter comprising at least one of the following: the set of ranging values, the first offset, and the first position adjustment amount; and
outputting prompt information if the target parameter does not meet the preset condition.

14. The spot check method according to claim 13, wherein
if the target parameter comprises the set of ranging values, the preset condition comprises at least one of the following: a range of all ranging values in the set of ranging values being within a preset range scope; and a first distance difference corresponding to each ranging value in the set of ranging values being within a preset first distance difference scope, wherein the first distance difference corresponding to the ranging value is a distance difference between the ranging value and a reference distance, and the reference distance is a distance between the calibrated rangefinder and the focal point;
if the target parameter comprises the first offset, the preset condition comprises: the first offset being within a preset offset scope; and
if the target parameter comprises the first position adjustment amount, the preset condition comprises: the first position adjustment amount being within a preset first adjustment amount scope.

15. The spot check method according to claim 13,
wherein the target parameter comprises the first position adjustment amount, and the preset condition comprises at least one of the following: a difference between a second position adjustment amount and the first position adjustment amount being within an adjustment difference scope, and a second distance difference corresponding to each ranging value in the set of ranging values being within a preset second distance difference scope, wherein the second distance difference corresponding to the ranging value is a sum of a first distance difference corresponding to the ranging value and the second position adjustment amount, the first distance difference corresponding to the ranging value is a distance difference between the ranging value and a reference distance, and the reference distance is a distance between the calibrated rangefinder and the focal point;
the method further comprising:
obtaining a first ranging value and a second ranging value for a preset ranging point, the first ranging value being obtained by the rangefinder through ranging of the preset ranging point in the first direction before subjecting the laser galvanometer to the position adjustment in the first direction, and the second ranging value being obtained by the rangefinder through ranging of the preset ranging point in the first direction after subjecting the laser galvanometer to the position adjustment in the first direction; and
determining the second position adjustment amount based on a difference between the second ranging value and the first ranging value.

16. The spot check method according to claim 15,
wherein the preset condition comprises: a second defocus amount being within a preset defocus amount scope;
the method further comprising:
determining the second defocus amount based on a sum of the second position adjustment amount and the first offset.

17. The spot check method according to claim 6, further comprising:
sending a check instruction to the robot, the check instruction being used to instruct the robot to drive the rangefinder to move, in the first direction, to a preset check position and then perform ranging of an upper surface of a calibration block, the calibration block being fixedly disposed in a welding station, and the upper surface being at a preset check distance from the check position in the first direction;
obtaining a third ranging value that is obtained by the rangefinder through ranging of the upper surface; and
determining a check result for the rangefinder based on the third ranging value and the check distance;
wherein obtaining the set of ranging values between the rangefinder and the at least two posts in the battery product to be welded comprises:
obtaining the set of ranging values between the at least two posts and the rangefinder if the check result represents a check success.

18. The spot check method according to claim 17, wherein:
the calibration block has a plurality of steps, and in the first direction, an upper surface of each of the steps is at a preset check distance from the check position;
obtaining the third ranging value that is obtained by the rangefinder through ranging of the upper surface comprises:
obtaining a third set of ranging values that is obtained by the rangefinder through ranging of the upper surface of at least one of the steps; and
determining the check result for the rangefinder based on the third ranging value and the check distance comprises:
determining the check result for the rangefinder based on the third set of ranging values and the check distance corresponding to the upper surface of each of the at least one of the steps.
